(19) United States
(12) Patent Application Publication
(10) Pub. No.: US 2024/0070421 A1
(43) Pub. Date: Feb. 29, 2024

(54) PRINTING DEVICE CONSUMABLE ITEM END OF LIFE PREDICTION

(71) Applicant: Hewlett-Packard Development Company, L.P., Spring, TX (US)

(72) Inventors: Scott K. Hymas, Boise, ID (US); Jeffrey H. Luke, Boise, ID (US); Gabriel S. McDaniel, Boise, ID (US)

(21) Appl. No.: 18/271,214

(22) PCT Filed: Jan. 15, 2021
(86) PCT No.: PCT/US2021/013566

§ 371 Date: Jul. 6, 2023

(51) Int. Cl. G06K 15/00

(52) U.S. Cl. CPC G06K 15/4075; G06K 15/402

(57) ABSTRACT

The number of days until a consumable item of a printing device reaches end of life is predicted based on a usage scenario of the printing device. An expected fulfillment time period is subtracted from the predicted number of days to determine a number of days until a fulfillment event occurs. A threshold remaining life of the consumable item is correlated with the number of days until the fulfillment event occurs. That the remaining life of the consumable item has reached the threshold remaining life is detected, and fulfillment of a replacement consumable item to replace the consumable item is responsively initiated.

### BACKGROUND

Printing devices can use a variety of different technologies to form images on media such as paper or to build three-dimensional (3D) objects. Such technologies include dry electrophotography (EP) and liquid EP (LEP) technologies, which may be considered as different types of laser and light-emitting diode (LED) printing technologies, as well as inkjet-printing technologies and three-dimensional (3D) printing technologies. Printing devices deposit print material, such as colorant like toner, ink (which can include other printing fluids or material as well), or 3D print material.

### BRIEF DESCRIPTION OF THE DRAWINGS

FIG. 1 is a diagram of an example graph depicting projected end of life of a consumable item for a printing device according to different usage scenarios of the printing device.

FIG. 2 is a flowchart of an example method for determining threshold remaining life at which fulfillment of a replacement consumable item for a printing device is to be initiated for a determined usage scenario of the printing device.

FIGS. 3A, 3B, and 3C are diagrams of three different example usage scenarios of a printing device.

FIG. 4 is a diagram of another example method for determining threshold remaining life at which fulfillment of a replacement consumable item for a printing device is to be initiated for a determined usage scenario of the printing device.

FIGS. 5A, 5B, and 5C are diagrams of example performance of the method of FIG. 4.

FIG. 6 is a diagram of an example system in which a computing device initiates fulfillment of a consumable item for a printing device.

FIG. 7 is a diagram of an example method.

FIG. 8 is a diagram of an example non-transitory computer-readable data storage medium.

FIG. 9 is a diagram of an example printing device.

### DETAILED DESCRIPTION

As noted in the background, printing devices deposit print material to form images on media or, in the case of three-dimensional (3D) printing devices, to additively build (3D) objects. A printing device can include a cartridge of print material that the device uses for printing. The term cartridge as used herein includes any type of print material supply that can be connected to or installed within a printing device. As the printing device prints print jobs, print material is consumed from the cartridge. When the cartridge is empty or is running low on print material, the cartridge may be replaced with a replacement cartridge that has a fresh (e.g., full) supply of print material.

The replacement cartridge may be automatically or manually ordered or shipped to an end user or other party responsible for replacing the currently installed cartridge with the replacement cartridge. For example, when the printing device is starting to run low on print material, the device may alert the user, who may then manually order a replacement cartridge. As another example, the printing device may be in communication with a computing device over a network, in accordance with a service that the end user has purchased or to which the end user has subscribed, so that a replacement cartridge is automatically shipped at the appropriate time.

The replacement cartridge may be automatically or manually ordered or shipped when the remaining life of the currently installed cartridge (e.g., the number of remaining pages that the print material of the cartridge can print) reaches a threshold. The remaining life of the cartridge in this respect may be the estimated or actual remaining life. Once the remaining life has reached the threshold and the replacement cartridge ordered or shipped, the user may, however, print frequently enough that the replacement cartridge arrives after the currently installed cartridge becomes depleted. Therefore, the printing device is unable to print for a period of time. Conversely, once the remaining life has reached the threshold and the replacement cartridge ordered or shipped, the user may print infrequently enough that the replacement cartridge arrives well in advance of when the currently installed cartridge becomes depleted. Therefore, the party responsible for the replacement cartridge prematurely incurs cost.

Techniques described herein ameliorate these and other issues. The number of days until the currently installed cartridge is expected to become depleted is determined based on the usage scenario of the printing device. The usage scenario may be manually selected by the user, automatically selected from a number of preexisting usage scenarios based on historical usage of the printing device, determined using a machine learning model, or in another manner.

What is referred to as an expected fulfillment time period for a replacement cartridge to arrive at the printing device is subtracted from the determined number of days until the expected depletion of the currently installed cartridge. A threshold remaining life is correlated with the resulting number of days. When the currently installed reaches this threshold remaining life, fulfillment of the replacement cartridge is initiated. Fulfillment of the replacement cartridge means that processing that results in shipment of the replacement cartridge to a user of the printing device is initiated. Fulfillment is completed with the arrival of the replacement cartridge at the printing device. The expected fulfillment period is thus the length of time between replacement cartridge fulfillment initiation and arrival of the replacement cartridge at the printing device.

The threshold remaining life is therefore effectively based on the usage scenario of the printing device, which corresponds to a usage profile of the printing device that conforms to historical usage and/or expected future usage of the printing device. As a result, the replacement cartridge is more likely to arrive just before the currently installed cartridge becomes depleted. Replacement cartridge fulfillment cost is therefore less likely to be prematurely incurred, and similarly the likelihood that the replacement cartridge will arrive after the currently installed cartridge has become depleted is minimized.

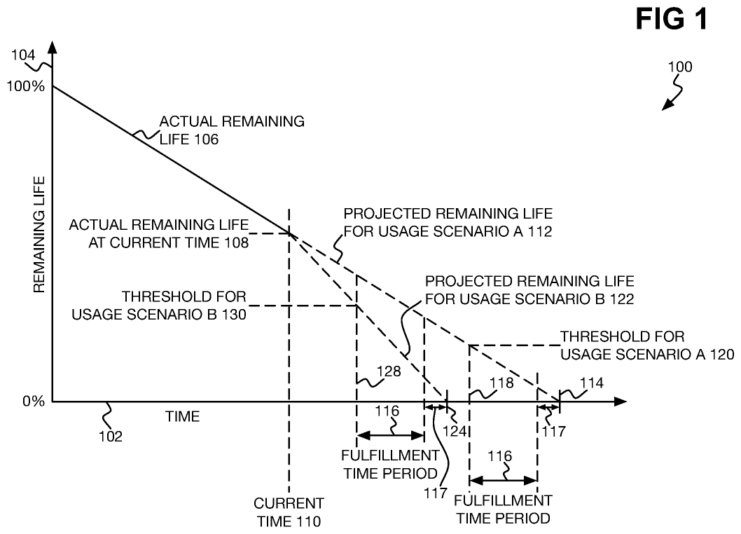

FIG. 1 is a diagram of an example graph depicting projected end of life of a consumable item for a printing device according to different usage scenarios of the printing device. A consumable item for a printing device can include a cartridge of print material, such as ink or toner, another type of colorant supply other than a cartridge, or another type of consumable item altogether, such as a fuser or developer module in the case of a laser-printing device. As noted above, fulfillment of a consumable item means that processing that results in shipment of the consumable item to a user of the printing device is initiated. Fulfillment is completed with the arrival of the consumable item at the printing device.

The graph 100 includes an x-axis 102 denoting time, and a y-axis 104 denoting consumable item remaining life. As depicted in FIG. 1, consumable item remaining life is measured from 100% down to 0% (i.e., end of life). For example, for a colorant supply like a cartridge of print material, 100% remaining life corresponds to the supply being full and 0% remaining life corresponds to the supply being empty. Consumable item remaining life may instead be measured in the number of pages that can still be printed, or using some other unit of measure, rather than by percentage.

The graph 100 depicts a line 106 corresponding to the remaining life of a consumable item currently installed within the printing device. As the printing device is used for printing, the device depletes the consumable item. The line 106 is solid in correspondence with the actual remaining life of the consumable item. At the current time 110, the consumable item has an actual remaining life 108. However, the projected remaining life of the consumable after the current time 110 item can differ depending on how the printing device is expected to be used in the future. That is, the projected remaining life of the consumable item depends on the usage scenario of the printing device.

The graph 100 depicts a dashed line 112 starting at the current time 110, which corresponds to the projected remaining life of the currently installed consumable item according to a usage scenario A. Continued usage of the printing device under usage scenario A is expected to result in the consumable item reaching end of life at time 114. A fulfillment time period 116 is depicted that corresponds to how long fulfillment of a replacement consumable item, and thus arrival of the replacement consumable item at the printing device, will take upon initiation.

The fulfillment time period 116, along with a margin 117, is subtracted from time 114 when the currently installed consumable item is expected to reach end of life in usage scenario A, to determine time 118 at which fulfillment of the replacement consumable item should be initiated in this usage scenario. Time 118 in turn is correlated with consumable item life to determine a threshold remaining life 120 for usage scenario A. Therefore, under usage scenario A, replacement consumable item fulfillment is initiated responsive to the actual remaining life of the currently installed consumable item reaching the threshold remaining life 120.

The graph 100 also depicts a dashed line 122 starting at the current time 110, which corresponds to the projected remaining life of the currently installed consumable item according to a usage scenario B that is more aggressive than usage scenario A. Continued usage of the printing device under usage scenario B is expected to result in the consumable item reaching end of life at time 124. The same fulfillment time period, along with the same margin 117, can be subtracted from time 124 to determine time 128 at which fulfillment of the replacement consumable item should be initiated in usage scenario B.

Time 128 is again in turn correlated with consumable item life to determine a threshold remaining life 130 for usage scenario B. Under usage scenario B, then, replacement consumable item fulfillment is initiated responsive to the actual remaining life of the currently installed consumable item reaching the threshold remaining life 130. Therefore, in the example of FIG. 1, when fulfillment of a replacement consumable item is initiated depends on the selected usage scenario of the printing device. Different usage scenarios have different remaining life thresholds that trigger replacement consumable item fulfillment.

Whereas two usage scenarios A and B are described in the example of FIG. 1, there can be more than two usage scenarios. The usage scenarios may be prespecified usage scenarios, from which the usage scenario governing initiation of replacement consumable item fulfillment is manually or automatically selected. The usage scenario may instead be a dynamic usage scenario that is generated for a particular printing device, based on the historical usage and/or expected future usage of the printing device.

The usage scenario may be periodically updated. For example, the usage scenario may be updated each time a new consumable item is installed within the printing device. The usage scenario may additionally or instead be updated periodically over time, as the currently installed consumable item is used. Furthermore, for a given usage scenario, the threshold remaining life that triggers replacement consumable item fulfillment may be calculated when a new consumable item is installed within the printing device, and may likewise be periodically updated as the currently installed consumable item is used.

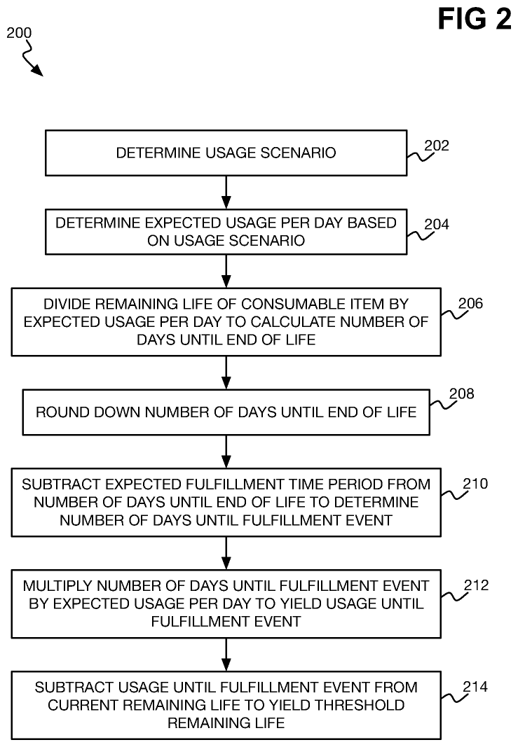

FIG. 2 shows an example method 200 for determining threshold remaining life at which fulfillment of a replacement consumable item for a printing device is to be initiated for a determined usage scenario of the printing device. The method 200 may be implemented as program code stored on a non-transitory computer-readable data storage medium and executed by a processor. The processor may be part of the printing device itself, such that the printing device performs the method 200. The processor may instead be part of a computing device, such as a server like a cloud computing server, which is in communication with the printing device over a network, and such that the computing device performs the method 200.

The method 200 includes determining the usage scenario of the printing device (202). The usage scenario corresponds to the usage profile of the printing device that conforms to historical usage and/or expected future usage of the printing device. The usage scenario may be determined in one of a number of different ways. For example, the processor performing the method 200 may receive user selection of the usage scenario. The user may select from a number of prespecified usage scenarios, or may construct a custom usage scenario from scratch or by modifying an existing usage scenario.

As another example, the usage scenario may be determined by determining which of a number of prespecified usage scenarios best conforms to the historical usage of the printing device. More recent usage of the printing device may be weighted more than less recent usage in this respect, for instance. As a third example, the usage scenario may be determined using a machine learning model, based on the historical usage of the printing device. The machine learning model may generate a custom usage scenario for the printing device, or may select one of a number of prespecified usage scenarios.

The method 200 includes determining the expected usage per day based on the determined usage scenario (204). The expected usage per day is the daily amount by which the remaining life of the consumable item is expected to be depleted due to usage of the printing device. Each usage scenario may specify a single corresponding daily expected usage of the consumable item. As another example, a usage scenario may specify the daily expected usage of the consumable item by day of the week, week of the month, and/or month of the year, from which the average or other statistic (e.g., median, and so on) of overall daily expected usage may be calculated. Therefore, in either case, the processor performing the method 200 can retrieve the expected usage per day of the consumable item for the determined usage scenario.

The method 200 includes dividing the current remaining life of the currently installed consumable item by the expected usage per day to calculate the number of days until the consumable item is expected to reach end of life (206). The method 200 can include rounding down the calculated number of days until the consumable item is expected to reach end of life to the nearest integer (208). In this way, then, the predicted number of days until the consumable item reaches end of life is determined.

The method 200 includes subtracting an expected fulfillment time period from the predicted number of days until the consumable item reaches end of life, to determine a number of days until a fulfillment event occurs (210). The expected fulfillment time period specifies how long, in days, arrival of a replacement consumable item is expected to take once fulfillment of the replacement consumable item has been initiated. That is, the expected fulfillment time period includes the number of days between initiation of replacement consumable item fulfillment and expected arrival of the replacement consumable item at the printing device. A margin, similarly specified in days, may also be subtracted, or may be part of the expected fulfillment time period that is subtracted.

The determined number of days until the fulfillment event occurs corresponds to when fulfillment of the replacement consumable item should be initiated under the determined usage scenario. However, replacement consumable item fulfillment is in actuality initiated when the remaining life of the currently installed fulfillment reaches a threshold remaining life. Therefore, the threshold remaining life is correlated with the determined number of days until the fulfillment event occurs.

Specifically, the method 200 includes multiplying the determined number of days until the fulfillment event occurs by the expected usage per day for the determined usage scenario to yield the additional usage of the currently installed consumable item that has to occur before the fulfillment event is triggered (212). The method 200 includes then subtracting this determined additional usage from the current remaining life of the consumable item currently installed within the printing device to yield the threshold remaining life (214). Therefore, when the remaining life of the currently installed consumable item reaches the threshold remaining life, fulfillment of a replacement consumable item is initiated.

In FIG. 2, the threshold remaining life is determined based on an expected daily usage for the determined usage scenario of the printing device that is in effect a singular value. That is, the usage scenario either specifies a single expected daily usage, or an average or other statistic of overall single expected daily usage is otherwise determined for the usage scenario. However, the threshold remaining life may instead be determined based on an expected daily usage that varies depending on the actual day in question, such as according to the day of the week, month, or year; the week of the month; the month of the year; or in another manner.

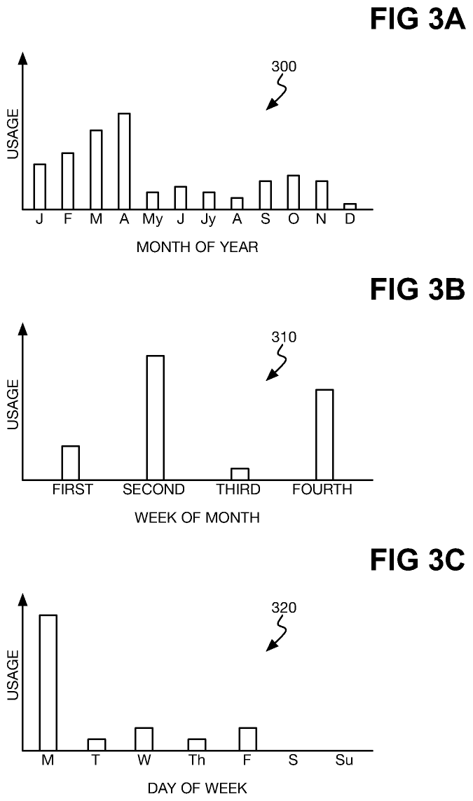

FIGS. 3A, 3B, and 3C show different example usage scenarios 300, 310, and 320 of a printing device, respectively. The usage scenario 300 specifies the expected daily usage of the printing device by month of the year. The usage scenario 300 may correspond to the daily usage of an accountant, for instance, in which expected usage of the printing device is greater in the months leading up to and including April than in other months.

The usage scenario 310 specifies the expected daily usage of the printing device by week of the month. The usage scenario 310 may correspond to the daily usage of a payroll department, for instance, in which paper checks are printed in the middle and at the end of each month. The usage scenario 320 specifies the expected daily usage of the printing device by day of the week. The usage scenario 320 may correspond to the daily usage of a small business, for instance, in which most printing occurs at the start of the week and no printing occurs on weekends.

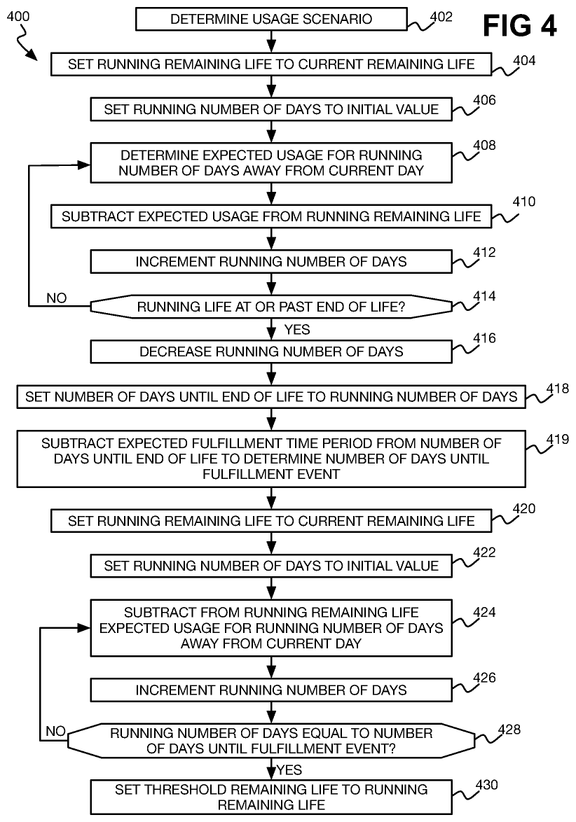

FIG. 4 shows another example method 400 for determining threshold remaining life at which fulfillment of a replacement consumable item for a printing device is to be initiated for a determined usage scenario of the printing device. The method 400 differs from the method 200 of FIG. 2 in that the expected daily usage can differ depending on the actual day. However, like the method 200, the method 400 may be implemented as program code stored on a non-transitory computer-readable data storage medium and executed by a processor, which may be part of the printing device itself or a computing device to which the printing device is communicatively connected.

The method 400 includes determining the usage scenario of the printing device (402), as has been described in relation to FIG. 2. The method 400 includes setting a running remaining life of the consumable item currently installed within the printing device to the current remaining life of this consumable item (404). The running remaining life is a variable used within the method 400 to track projected remaining life under a determined usage scenario. The method 400 also includes setting a running number of days to an initial value (406), such as zero to denote the current day, or one to denote the day after the current day. The running number of days is a variable used within the method 400 to track the number of days in the future at which the consumable item has a projected remaining life denoted by the running remaining life.

The method 400 includes determining the expected usage for the day that is the running number of days away from the current day (408), based on the determined usage scenario. For example, if the usage scenario specifies expected daily usage by day of the week, then the expected usage determined for the day that is the running number of days away from the current day depends on which day of the week this day is. As another example, if the usage scenario specifies expected daily usage by month of the year, then the expected usage determined for the day that is the running number of days away from the current day depends on in which month this day is.

The method 400 includes subtracting the expected usage from the running remaining life of the currently installed consumable item (410), and incrementing the running number of days by one day (412). If the running life of the currently installed consumable item is not yet at or past end of life (414), the method 400 is repeated at part 408 for the next day. Parts 408, 410, and 412 are thus repeated until the running remaining life of the currently installed consumable item reaches end of life, such as when the running remaining life is less than or equal to zero by percentage life remaining. At this running remaining life, the running number of days roughly corresponds to the number of days in the future when the consumable item is expected to reach end of life.

However, the method 400 can include decreasing the running number of days (416), such as by subtracting one or two days from the running number of days that remain when the running remaining life of the currently installed consumable item has reached end of life. The remaining running number of days may be decremented by one day to compensate for the final incrementation of the running number of days in part 412, so that the running number of days better corresponds to the number of days in the future when the consumable item is expected to reach end of life. The remaining number of days may be decremented by two days to compensate for this final incrementation in part 412 in the case where the running number of days was initially set to one day in part 406, similarly so that the running number of days better corresponds to the number of days in the future when the consumable item is expected to reach end of life.

The method 400 therefore includes then setting the number of days until the currently installed consumable item is expected to reach end of life to the remaining number of days (418). The method 400 includes subtracting an expected fulfillment time period from this resulting predicted number of days until the consumable item reaches end of life, to determine a number of days until a fulfillment event occurs (419), as in part 210 of the method 200 of FIG. 2. As in part 210, a margin can also be subtracted, or the expected fulfillment time period may include the margin.

The method 400 next determines the threshold remaining life of the currently installed consumable item that corresponds to or correlates with the determined number of days in the future at which the fulfillment event is expected to occur. Specifically, the method 400 includes (re)setting the running of the currently installed consumable item to the currently remaining life of this cartridge again (420), as well as (re)setting the running number of days to the initial value again (422). As noted above, the running remaining life is a variable used within the method 400 to track projected remaining life under a determined usage scenario, and running the number of days is a variable used within the method 400 to track the number of days in the future at which the consumable item has a projected remaining life denoted by the running remaining life.

The method 400 includes subtracting from the running remaining life of the currently installed cartridge the previously determined expected usage for the running number of days away from the current day (424). The method 400 includes then incrementing the running number of days by one day (426). If the running number of days is not yet equal to the number of days until the fulfillment event occurs (428), then the method 400 is repeated at part 408 for the next day. Parts 424 and 426 are thus repeated until the running number of days is equal to the number of days at which the fulfillment event is expected to occur. At this running number of days, the running remaining life thus corresponds to the threshold at which the fulfillment event is expected to occur. The method 400 includes therefore setting the threshold remaining life at which fulfillment of a replacement consumable item is to be triggered to the running remaining life (430).

The running remaining life and the running number of days variables are used differently in the loop between parts 424-428 and the loop between parts 408-414. In the loop between parts 408-414, the running remaining life, which is initially set to the current remaining life, is decreased until it reaches end of life, such that the resulting running number of days corresponds to when end of life is expected to be reached. By comparison, in the loop between parts 424-428, the running number of days is incremented until it reaches when the fulfillment event is expected to occur, such that the resulting running remain life corresponds to the threshold remaining life when the fulfillment event is expected to occur.

In FIG. 4, the threshold remaining life is determined based on an expected daily usage for the determined usage scenario of the printing device that can vary by day. That is, the expected daily usage can change in accordance with how many days away from the current day a given day in question is, as dictated by the usage scenario. As noted, the usage scenario may specify expected daily usage by day of the year (i.e., the actual date), week, or month, by week of the month or year, and so on.

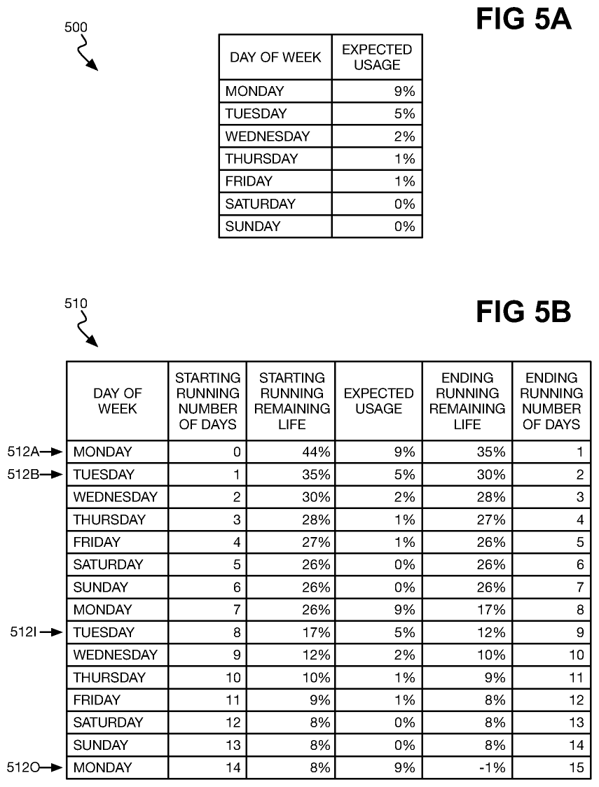

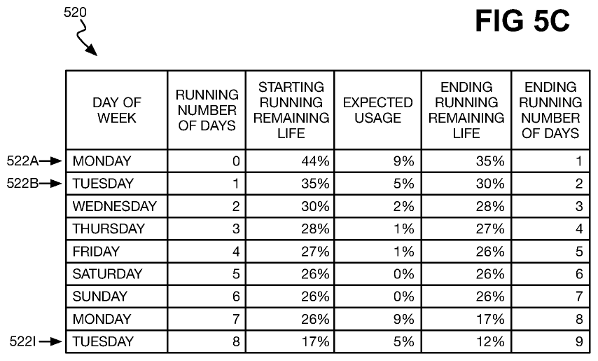

FIGS. 5A, 5B, and 5C depict example performance of the method 400 of FIG. 4. FIG. 5A shows an example table 500 representing the usage scenario of a printing device as determined in part 402 of the method 400. The usage scenario specifies the expected usage of a consumable item of the printing device in terms of the amount by which the remaining life of the consumable item is expected to decrease for a given day of the week. Specifically, the expected usage is highest on Monday, at 9% of the remaining consumable item life, and then decreases to 5% on Tuesday, 2% on Wednesday, 1% on Thursday and Friday, and 0% on Saturday and Sunday.

FIG. 5B shows an example table 510 representing iterative performance of parts 408-414 of the method 400 of FIG. 4 after the running remaining life has been set to the current remaining life of the consumable item in part 404 and the running number of days has been set to an initial value of zero in part 406. In the example, the current remaining life of the consumable item, and thus the initial value of the running remaining life, is 44%. Furthermore, the current day of the week is a Monday in the example. The table 510 includes rows 512A, 512B, . . . , 512I, . . . , 512O, which are collectively referred to as the rows 512. Each row 512 corresponds to one iteration of parts 408-414 of the method 400 of FIG. 4.

The row 512A thus corresponds to the first iteration. The starting running number of days and the starting running remaining life are the running number of days and the running remaining life at the outset of the iteration, and therefore are equal to zero and 44%, respectively. This running number of days away from the current day—which is the current day, since the running number of days is zero—is a Monday, and therefore the expected usage of the consumable item is 9% per the table 500 of FIG. 5A. The running remaining life is decreased by this expected usage, such that the ending running remaining life—i.e., the running remaining life at the end of the iteration—is 35%. The running number of days is incremented by one day, such that the ending running number of days—i.e., the running number of days at the end of the iteration—is one.

The row 512B corresponds to the second iteration. The starting running number of days at the outset of this iteration is equal to the ending running number of days at the end of the prior iteration, or one. Likewise, the starting running remaining life for this iteration is equal to the ending running remaining life of the prior iteration, or 35%. This running number of days away from the current day—i.e., one day away from the current day, which is the day after the current day—is a Tuesday, and therefore the expected usage of the consumable item is 5% per the table 500 of FIG. 5A. The running remaining life is decreased by this expected usage, such that the ending running remaining life for this iteration is 30%. The running number of days is incremented by one day, resulting in an ending running number of days of two.

This process is repeated for each iteration. For example, for the iteration to which the row 512I corresponds, the starting running remaining life is 17%, and the starting running number of days is eight. This running number of days away from the current day—i.e., eight days, or one week and one day, away from the current day—is a Tuesday, and therefore the expected usage of the consumable item is 5% per the table 500 of FIG. 5A. The running remaining life is decreased by this expected usage, such that the ending running remaining life for this iteration is 12%. The running number of days is incremented by one day, resulting in an ending running number of days of nine.

The row 512O corresponds to the last iteration, at which the ending running remaining life has reached end of life—i.e., equal to or less than 0%. The currently installed consumable item of the printing device is therefore expected to reach end of life fourteen days away from the current day, which is the starting running number of days at the outset of the last iteration. However, because—as in each iteration—the running number of days is incremented in the last iteration, the ending running number of days for the last iteration is fifteen. Therefore, in accordance with part 416 of the method 400 of FIG. 4, the running number of days is decreased to fourteen.

Per part 418 of the method 400 of FIG. 4, the number of days until end of life is expected to be reached is thus set to this resulting running number of days (i.e., fourteen days). In the example, the expected fulfillment time period is five days. Therefore, five days is subtracted from fourteen days (i.e., the number of days until end of life is expected to be reached) in part 419 of the method 400, to yield nine days until the fulfillment event. The remainder of the method 400 is then performed to determine the threshold remaining life corresponding to nine days away from the current day, which is the threshold remaining life at which fulfillment of a replacement cartridge will be initiated.

Accordingly, FIG. 5C shows an example table 520 representing iterative performance of parts 424-428 of the method 400 of FIG. 4 after the running remaining life has been reset to the current remaining life of the consumable item in part 420—viz., 44%— and the running number of days has been reset to the initial value of zero in part 422. The table 520 includes rows 522A, 522B, . . . , 522I, collectively referred to as the rows 522, and which are identical to the rows 512A, 512B, . . . , 512I of the table 510 of FIG. 5B. Each row 522 corresponds to one iteration of parts 424-428 of the method 400.

The row 522A thus corresponds to the first iteration. The starting running number of days and the starting running remaining life are equal to zero and 44%, respectively. This running number of days away from the current day is a Monday, and therefore the expected usage of the consumable item is 9% per the table 500 of FIG. 5A. The running remaining life is decreased by this expected usage, such that the ending running remaining life is 35%. The running number of days is incremented by one day, such that the ending running number of days is one.

The row 522B corresponds to the second iteration. The starting running number of days is one, and the starting running remaining life for this iteration is 35%. This running number of days away from the current day is a Tuesday, and therefore the expected usage of the consumable item is 5% per the table 500 of FIG. 5A. The running remaining life is decreased by this expected usage, such that the ending running remaining life for this iteration is 30%.

This process is repeated for each iteration. The row 522I correspond to the last iteration, at which the ending running number of days has reached the number of days until the fulfillment event, which is nine days. The ending running remaining life for this iteration—12%— is therefore set in part 430 of the method 400 of FIG. 4 as the threshold remaining life at which the fulfillment event occurs. Under the usage scenario represented by the table 500 of FIG. 5A, then, when the remaining life of the currently installed consumable item reaches 12%, replacement cartridge fulfillment is initiated in the example.

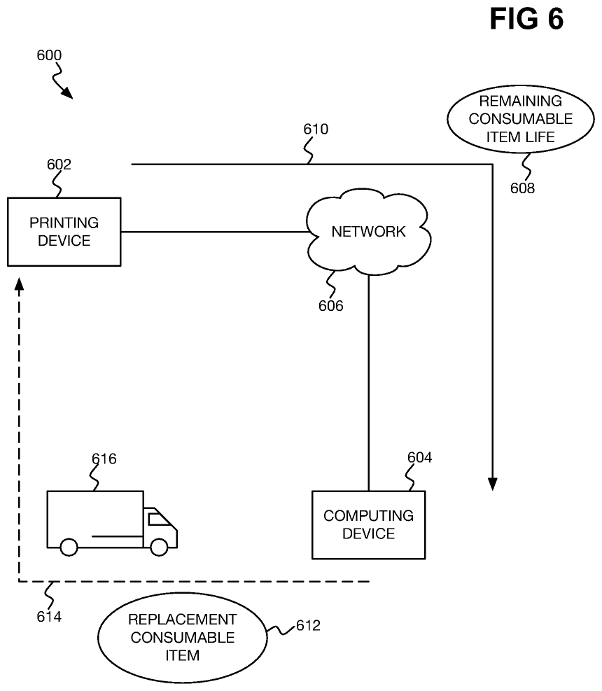

FIG. 6 shows an example system 600. The system 600 includes a printing device 602 and a computing device 604. The printing device 602 may be a standalone printer or an all-in-one (AIO) device that combines printing functionality with other functionality, such as scanning functionality. The computing device 604 may be a server, such as a cloud computing server, or another type of computing device. The printing device 602 and the computing device 604 are communicatively connected to one another over to a network 606, such as wired or wireless networks, intranets, extranets, the Internet, and so on.

As depicted in FIG. 6, the printing device 602 may be directly connected to the network 606 without an intermediary host computing device like a desktop or laptop computer. For instance, the printing device 602 may include a wired network port, such as an Ethernet port, and/or may have wireless communication capability, such as Wi-Fi or another type of wireless local area network (WLAN) communication capability. In another implementation, however, the printing device 602 may be communicatively connected to a host computing device, such as via a universal serial bus (USB) wired connection or a Bluetooth wireless connection. In such an implementation, the host computing device is communicatively connected to the network 606, and the printing device 602 communicates over the network 606 through the host computing device.

The printing device 602 repeatingly sends the remaining life 608 of a currently installed consumable item to the computing device 604, which thus repeatingly receives the remaining consumable item life 608 from the printing device 602 over the network 606, per arrow 610. For example, the printing device 602 may periodically send the remaining consumable item life 608 at regular time intervals, such as daily. As another example, the printing device 602 may send the remaining consumable item life 608 each time the device 602 uses the consumable item to print a print job, or in batches after a number of print jobs have been printed.

In the example of FIG. 6, the computing device 604 can determine the threshold remaining life at which fulfillment of a replacement consumable item 612 is to be initiated, as has been described. The computing device 604 can further detect that the received remaining consumable item life 608 has reached this threshold remaining life. The computing device 604 may thus responsively initiate fulfillment of the replacement consumable item 612. Per arrow 614, such fulfillment initiation results in shipment of the replacement consumable item 612 to the printing device 602, such as via freight as represented in FIG. 6 by truck 616.

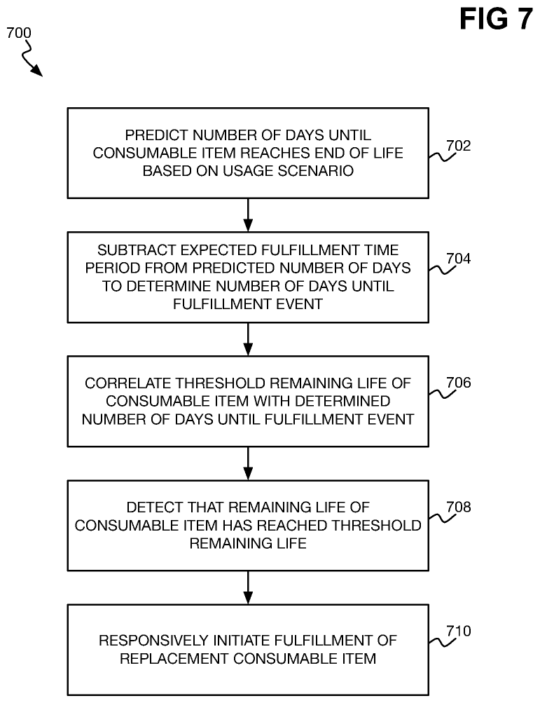

FIG. 7 shows an example method 700. The method 700 can be implemented as program code stored on a non-transitory computer-readable data storage medium and executed by a processor of a printing device or a computing device to which the printing device is communicatively connected. The method 700 is consistent with and more general than the methods 200 and 400 of FIGS. 2 and 4.

The method 700 includes predicting the number of days until a consumable item of the printing device reaches end of life based on a usage scenario of the printing device (702). The method 700 includes subtracting an expected fulfillment time period from the predicted number of days to determine the number of days until a fulfillment event occurs (704), and correlating a threshold remaining life of the consumable item with the number of days until the fulfillment event occurs (706). The method includes then detecting that the remaining life of the consumable item has reached the threshold remaining life (708), and responsively initiating fulfillment of a replacement consumable item to replace the consumable item (710).

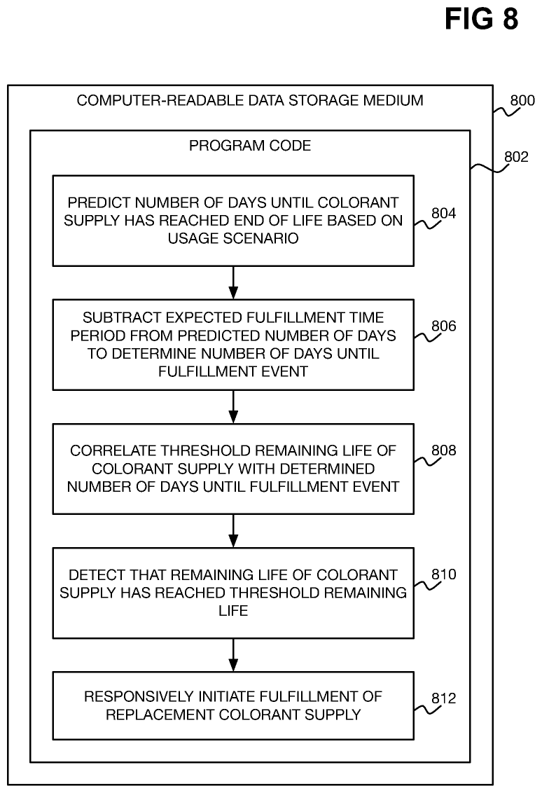

FIG. 8 shows an example non-transitory computer-readable data storage medium 800 storing program code 802. The program code 802 is executable by a processor, such as a processor of a printing device or a computing device to which the printing device is communicatively connected, to perform processing. The processing includes predicting the number of days until a colorant supply of the printing device reaches end of life based on a usage scenario of the printing device (804).

The processing includes subtracting an expected fulfillment time period from the predicted number of days to determine the number of days until a fulfillment event occurs (806), and correlating a threshold remaining life of the colorant supply with the number of days until the fulfillment event occurs (808). The processing includes detecting that the remaining life of the colorant supply has reached the threshold remaining life (810), and responsively initiating fulfillment of a replacement colorant supply to replace the colorant supply (812).

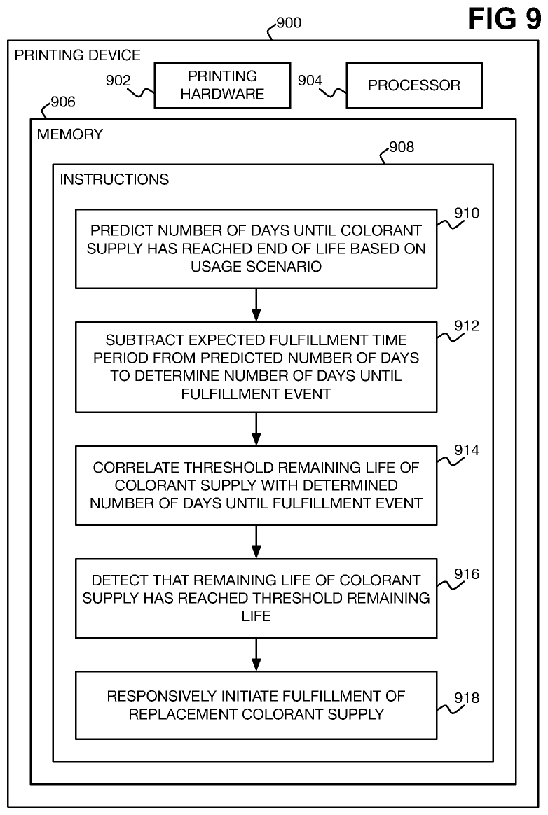

FIG. 9 shows an example printing device 900. The printing device 900 includes printing hardware 902 to print using colorant from a colorant supply installed within the printing device 900. For instance, the printing hardware 902 may include laser-printing hardware components such as a photoconductive drum, an optical beam source, a fuser, and so on, or may include inkjet-printing hardware components such as an inkjet printhead. The printing device 900 includes a processor 904 and a memory 906 storing instructions 908.

The instructions 908 are executable by the processor 904 to predict the number of days until the colorant supply reaches end of life based on a usage scenario of the printing device (910). The instructions 908 are executable by the processor 904 to subtract an expected fulfillment time period from the predicted number of days to determine the number of days until a fulfillment event occurs (912), and correlate a threshold remaining life of the colorant supply with the number of days until the fulfillment event occurs (914). The instructions 908 are executable by the processor 904 to detect that the remaining life of the colorant supply has reached the threshold remaining life (916), and responsively initiate fulfillment of a replacement colorant supply to replace the colorant supply (918).

Techniques have been described herein for ensuring that a replacement consumable item is not shipped to a user of a printing device too soon or too late. A threshold remaining life of a currently installed consumable item and at which fulfillment of the replacement consumable item is to be initiated is effectively determined based on the printing device's usage scenario. The replacement consumable item will thus likely arrive just before the currently installed consumable item reaches end of life.

We claim:

1. A method comprising:
predicting, by a processor, a number of days until a consumable item of a printing device reaches end of life based on a usage scenario of the printing device;
subtracting, by the processor, an expected fulfillment time period from the predicted number of days to determine a number of days until a fulfillment event occurs;
correlating, by the processor, a threshold remaining life of the consumable item with the number of days until the fulfillment event occurs;
detecting, by the processor, that a remaining life of the consumable item has reached the threshold remaining life; and
responsively initiating, by the processor, fulfillment of a replacement consumable item to replace the consumable item.

2. The method of claim 1, wherein the usage scenario of the printing device corresponds to a usage profile of the printing device that conforms to historical usage and/or expected future usage of the printing device.

3. The method of claim 1, wherein the expected fulfillment time period comprises a number of days between initiation of the fulfillment of the replacement consumable item and expected arrival of the replacement consumable item at the printing device.

4. The method of claim 1, wherein predicting the number of days until the consumable item of the printing device reaches the end of life based on the usage scenario of the printing device comprises:
determining the usage scenario of the printing device;
determining an expected usage per day of the consumable item based on the usage scenario; and
determining the number of days until the consumable item reaches the end of life based on the expected usage per day of the consumable item.

5. The method of claim 4, wherein determining the usage scenario of the printing device comprises:
receiving user selection of the usage scenario;
determining as the usage scenario which of a number of prespecified usage scenarios best conforms to historical usage of the printing device; or
using a machine learning model to determine the usage scenario based on the historical usage of the printing device.

6. The method of claim 4, wherein determining the expected usage per day of the consumable item of the printing device based on the usage scenario comprises:
retrieving the expected usage per day of the consumable item as specified for the usage scenario.

7. The method of claim 4, wherein determining the number of days until the consumable item of the printing device reaches the end of life based on the expected usage per day of the consumable item comprises:
dividing the remaining life of the consumable item by the expected usage per day of the consumable item to calculate the number of days until the consumable item reaches the end of life; and
rounding down to a nearest integer the calculated number of days until the consumable item reaches the end of life to yield the predicted number of days until the consumable item reaches the end of life.

8. The method of claim 7, wherein correlating the threshold remaining life of the consumable item with the number of days until the fulfillment event occurs comprises:
multiplying the predicted number of days until the fulfillment event occurs by the determined expected usage per day of the consumable item to yield a usage of the consumable item until the fulfillment event occurs; and
subtracting the usage of the consumable item until the fulfillment event occurs from the remaining life of the consumable item to yield the threshold remaining life.

9. The method of claim 1, wherein predicting the number of days until the consumable item of the printing device reaches the end of life based on the usage scenario of the printing device comprises:
determining the usage scenario of the printing device;
setting a running remaining life of the consumable item to the remaining life of the consumable item;
setting a running number of days to an initial value;
repeatingly determining an expected usage of the consumable item for the running number of days away from a current day based on the usage scenario, subtracting the determined expected usage from the running remaining life, and incrementing the running number of days, until the running remaining life reaches the end of life; and
setting the number of days until the consumable item reaches the end of life to the running number of days.

10. The method of claim 9, wherein the initial value to which the running number of days until the consumable item reaches the end of life is set to zero or one.

11. The method of claim 10, wherein predicting the number of days until the consumable item of the printing device reaches the end of life based on the usage scenario of the printing device further comprises:
subtracting one or two days from the running number of days before setting the number of days until the consumable item reaches the end of life to the running number of days.

12. The method of claim 9, wherein correlating the threshold remaining life of the consumable item with the number of days until the fulfillment event occurs comprises:
setting the running remaining life of the consumable item to the remaining life of the consumable item;
setting the running number of days to the initial value;
repeatingly subtracting from the running remaining life the determined expected usage for the running number of days away from the current day, and incrementing the running number of days by one, until the running number of days is equal to the number of days until the fulfillment event occurs; and
setting the threshold remaining life to the running remaining life.

13. A non-transitory computer-readable data storage medium storing program code executable by a processor to perform processing comprising:
predicting a number of days until a colorant supply of a printing device reaches end of life based on a usage scenario of the printing device;
subtracting an expected fulfillment time period from the predicted number of days to determine a number of days until a fulfillment event occurs;
correlating a threshold remaining life of the colorant supply with the number of days until the fulfillment event occurs;
detecting that a remaining life of the colorant supply has reached the threshold remaining life; and
responsively initiating fulfillment of a replacement colorant supply to replace the colorant supply.

14. The non-transitory computer-readable data storage medium of claim 13, wherein the processing comprises:
receiving the remaining life of the colorant supply from the printing device.

15. A printing device comprising:
printing hardware to print using colorant from a colorant supply installed within the printing device;
a processor; and
a memory storing instructions executable by the processor to:
predict a number of days until the colorant supply reaches end of life based on a usage scenario of the printing device;
subtract an expected fulfillment time period from the predicted number of days to determine a number of days until a fulfillment event occurs;
correlate a threshold remaining life of the colorant supply with the number of days until the fulfillment event occurs;
detect that a remaining life of the colorant supply has reached the threshold remaining life; and
responsively initiate fulfillment of a replacement colorant supply to replace the colorant supply.
